(19) United States
(12) Patent Application Publication
(10) Pub. No.: US 2005/0179831 A1
(43) Pub. Date: Aug. 18, 2005

(54) Liquid crystal display device

(76) Inventors: Takeshi Kaneki, Mobara (JP); Haruhisa Iida, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/041,214

(22) Filed: Jan. 25, 2005

(30) Foreign Application Priority Data
Jan. 27, 2004 (JP) 2004-018045

(51) Int. Cl. G02F 1/1333

(52) U.S. Cl. 349/58

(57) ABSTRACT

A liquid crystal display device avoids an interference fringe from being observed and provides a connector of simple constitution which supplies power to light sources of a backlight. The display device includes a liquid crystal display panel and a plurality of linear light sources which are arranged in parallel in a plane which faces at least a liquid crystal display part of the liquid crystal display panel. The linear light sources are driven with a signal waveform having the same frequency as data writing and are arranged in groups close to each other. The respective light sources of each group are driven with a signal waveform which is inverted with respect to the respective light sources of a neighboring group, and the signal waveform is supplied from a connector different from a connector used for the respective light sources of the other group.

### BACKGROUND OF THE INVENTION

The present invention relates in general to a liquid crystal display device, and, more particularly, to a liquid crystal display device which is provided with a so-called direct backlight.

In the backlight used in this type of liquid crystal display device, a plurality of light sources, which are provided in the form of cold cathode ray tubes, for example, are arranged in parallel on a surface which is parallel to at least a liquid crystal display part of a liquid crystal display panel. However, an undesired radiation (an electric field) which is generated from the respective cold cathode ray tubes exerts an undesirable influence on the liquid crystal display panel, thus giving rise to a drawback in that interference fringes are generated in the display provided in the liquid crystal display part.

Accordingly, to cope with such a drawback, a so-called ITO (indium tin oxide) sheet is interposed between the liquid crystal display panel and the backlight, so as to divert the undesired radiation from the respective cold cathode ray tubes to a frame (GND) the ITO sheet, thus reducing the influence of the undesired radiation on the liquid crystal display panel.

Here, the frame is formed as a frame body made of metal, which is provided for forming the liquid crystal display panel and the backlight into a module. As an example, the backlight, a power source circuit for driving the backlight and the like are described in Japanese Patent Laid-Open Hei11-297485, Japanese Patent Laid-Open Hei06-160804 and Japanese Patent Laid-Open Hei06-222329.

### SUMMARY OF THE INVENTION

However, since the above-mentioned liquid crystal display device uses an ITO sheet, a lowering of the brightness by approximately 10% is unavoidable. Accordingly, there has been a demand for another method which can obviate the interference fringes that can be observed on the liquid crystal display part with the naked eye without significantly lowering the brightness.

The present invention has been made under such circumstances, and it is an object of the invention to provide a liquid crystal display device which can prevent the interference fringes from being observed on a liquid crystal display part.

Further, it is another object of the invention to provide a liquid crystal display device in which a connector which supplies power to a light source of a backlight has a simple constitution.

A brief explanation of representative examples of the invention disclosed in this specification is as follows.

(1) The liquid crystal display device according to the present invention, for example, includes: a liquid crystal display panel; and a plurality of linear light sources which are arranged in parallel in a plane which faces at least a liquid crystal display part of the liquid crystal display panel, wherein

the respective linear light sources are driven with a voltage having a signal waveform of the same frequency as that used in data writing of the liquid crystal display panel,

the respective linear light sources are arranged close to each other and are formed into respective groups, and the respective linear light sources of each group are driven with a voltage having a signal waveform which is inverted with respect to that applied to the respective light sources of a neighboring group,

and the signal waveform is supplied to one group from a connector which is different from a connector used for the respective linear light sources of another group.

(2) The liquid crystal display device according to the invention is, for example, on the premise of the constitution (1), characterized in that the connector which is connected with the linear light sources of one group is configured separately from the connector which is connected with another group of linear light sources.

(3) The liquid crystal display device according to the invention is, for example, on the premise of the constitution (1), characterized in that each connector which supplies a driving voltage to the respective linear light sources of each group is arranged on one longitudinal side of the respective linear light sources.

(4) The liquid crystal display device according to the invention is, for example, on the premise of the constitution (1), characterized in that the respective linear light sources which are formed into a group are constituted of two linear light sources.

(5) The liquid crystal display device according to the invention, for example, includes: a liquid crystal display panel; and a plurality of linear light sources which are arranged in parallel in a plane which faces at least a liquid crystal display part of the liquid crystal display panel, wherein the respective linear light sources are driven with a signal waveform having the same frequency as data writing of the liquid crystal display panel and are divided into linear light sources of one group and linear light sources of another group, which are arranged every one or every other plurality of linear light sources in the parallel-arranged direction, and the signal waveform which is supplied to the respective linear light sources of one group is inverted with respect to that supplied to the respective linear light sources of another group, and the supply of the driving voltage to one group is performed by a connector which is different from a connector used for the respective linear light sources of another group.

(6) The liquid crystal display device according to the invention is, for example, characterized in that the respective linear light sources are divided into a plurality of groups which extend along a parallel-arranged direction, in each group, the respective linear light sources are divided into respective light sources of one group and another group, which are divided every other one in the parallel-arranged direction, the driving voltage which is supplied to the respective linear light sources of one group is inverted with respect to that supplied to the respective linear light sources of another group, and the supply of the driving voltage to one group is performed by a connector which is different from a connector used for the respective linear light sources of another group.

(7) The liquid crystal display device according to the invention is, for example, on the premise of the constitution (5) or (6), characterized in that the connector which supplies the driving voltage to the respective linear light sources of one group is arranged on one longitudinal side of the linear light sources, and the connector which supplies the driving voltage to the respective linear light sources of another group is arranged on another longitudinal side of the linear light sources.

The invention is not limited to the above-mentioned constitutions and various modifications can be made without departing from the technical concept of the invention.

### BRIEF DESCRIPTION OF THE SEVERAL VIEWS OF THE DRAWING

FIG. 1A and FIG. 1B illustrate one example of a connector which supplies a power source to a light source of a liquid crystal display device according to the invention, wherein FIG. 1A is a diagram showing a plan view of an inverter printed circuit board of the connector, and FIG. 1B is a diagram showing waveforms of voltage signals applied to the connector;

FIG. 2 is a diagram showing a developed view of one embodiment of the liquid crystal display device according to the invention;

FIG. 3 is an equivalent circuit diagram of a display region of the liquid crystal display device according to the invention;

FIG. 4 is a diagram showing another embodiment of a liquid crystal display device according to the invention; and

FIG. 5 is a graph showing experimental data illustrating an advantageous effect of the liquid crystal display device according to the invention.

### DETAILED DESCRIPTION OF THE INVENTION

Hereinafter, an embodiment of a liquid crystal display device according to the invention will be explained in conjunction with the drawings.

FIG. 2 is an exploded view of the liquid crystal display device which is formed into a module by sequentially stacking a frame FR, a liquid crystal display panel PNL, an optical sheet OS and a backlight BL, as seen from the front side of the device.

The liquid crystal display panel PNL is configured such that transparent substrates, which are arranged to face each other in an opposed manner with liquid crystal disposed therebetween, is used as an envelope, and a large number of pixels are provided in the spreading direction of the liquid crystal. The plurality of pixels constitute a display part AR, and the display part AR is positioned on a central part of the liquid crystal display panel PNL within a peripheral frame portion of the liquid crystal display panel PNL.

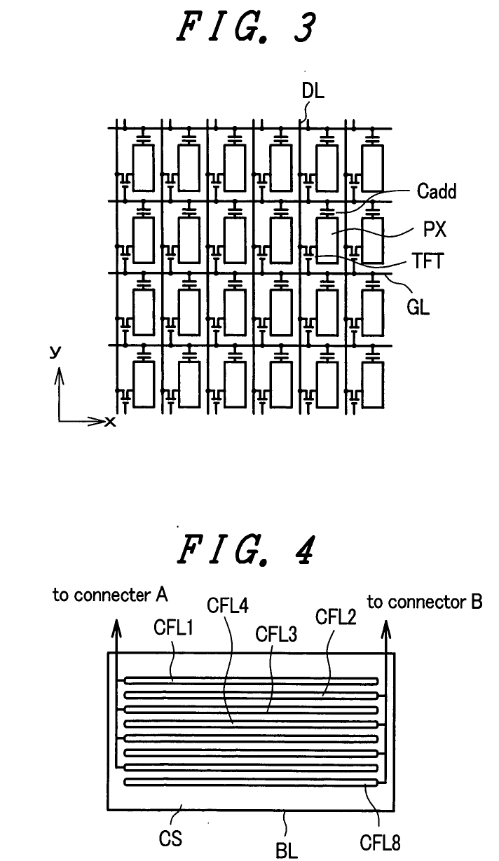

In the display part AR, as shown in FIG. 3, on a liquid-crystal-side surface of one of the above-mentioned transparent substrates, there are gate signal lines GL which extend in the x direction and are arranged in parallel in the y direction and drain signal lines DL which extend in the y direction and are arranged in parallel in the x direction, and regions which are surrounded by these respective signal lines constitute pixel regions.

Each pixel region includes a switching element TFT, which is turned on in response to a signal (a scanning signal) received from a one-side gate signal line GL, a pixel electrode PX to which a signal (a video signal) is supplied from the one-side drain signal line DL of the pixel region via the switching element TFT, and a capacitive element Cadd, which is formed between the pixel electrode PX and the other-side gate signal line GL of the pixel region.

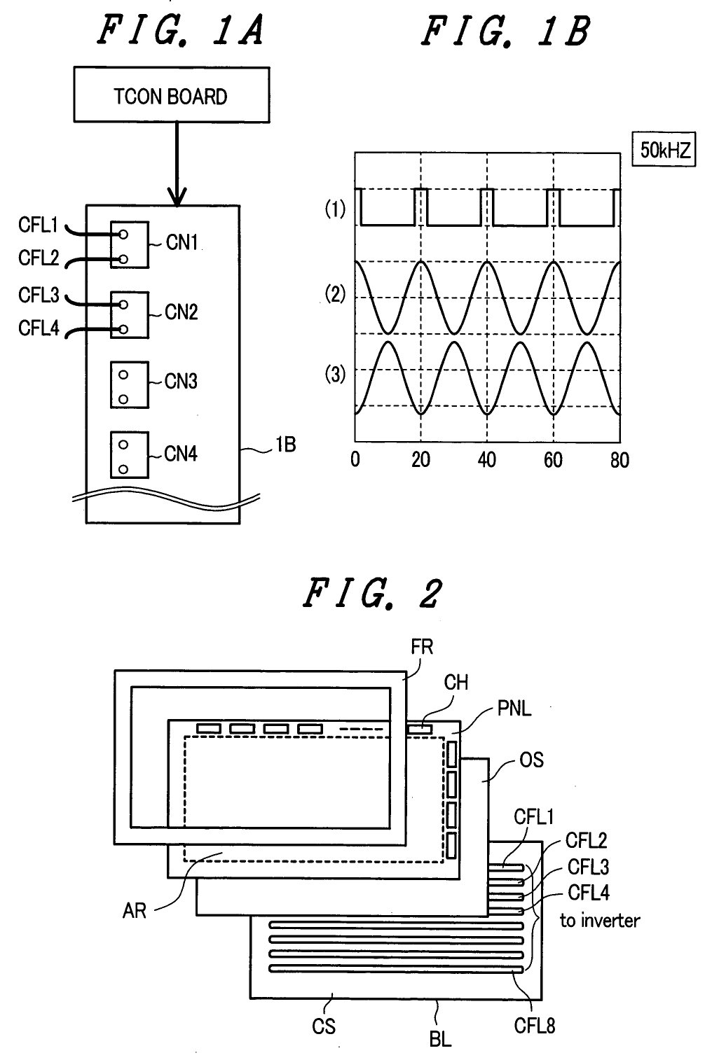

To the respective gate signal lines GL, a scanning signal is sequentially supplied along the parallel-arranged direction of the gate signal lines GL; and, in conformity with this timing of the supply of the scanning signal, the video signal is supplied to the respective drain signal lines DL. In this case, the supply of the scanning signal to the respective gate signal lines GL is also referred to as data writing. In this embodiment, the supply of the data writing signal is performed at a frequency of 50 kHz, for example, and the signal is supplied to the next gate signal line GL every 20 (μs). Here, a timing chart of the data writing signal is shown in line (1) in FIG. 1B.

The pixel electrode PX, to which the video signal is applied via the switching element TFT, generates an electric field between the pixel electrode PX and a counter electrode CT (not shown in the drawings) which is formed on a liquid-crystal-side surface of the other substrate of the above-mentioned transparent substrates, and the liquid crystal of the pixel is subjected to the optical modulation due to this electric field.

In this manner, in the liquid crystal display panel PNL, the liquid crystal of each pixel is subjected to optical modulation; and, hence, the liquid crystal display panel PL requires an external light. Hence, a backlight BL is arranged on a back surface of the liquid crystal display panel PNL with respect to an observer. Here, as seen in the drawing, an optical sheet OS is arranged between the liquid crystal display panel PNL and the backlight BL so as to cause, for example, a diffusion of the light from the backlight BL to the liquid crystal display panel PNL or the like.

The above-mentioned backlight BL is a so-called direct backlight, and it includes a light source disposed in a plane which constitutes a surface substantially parallel to the liquid crystal display panel PNL and faces the display part AR of the liquid crystal display panel PNL.

As such a light source, a plurality of, for example, eight, cold cathode ray tubes CFL1 to CFL8 are used, and these cathode ray tubes are arranged in parallel at equal intervals. Here, these cold cathode ray tubes CFL may be also referred to as linear light sources.

The respective cold cathode ray tubes CFL are supported on a chassis CS which has a light reflecting bottom surface, and the respective cold cathode ray tubes CFL are slightly spaced from this light reflecting bottom surface. The respective cold cathode ray tubes CFL constitute the backlight BL together with the chassis CS. The light from the respective cold cathode ray tubes CFL also includes, besides the light which is directed to the liquid crystal display panel PNL side, light which is reflected on the bottom surface of the chassis CS and then is directed to the liquid crystal display panel PNL side, thus realizing an effective utilization of the light.

Further, these cold cathode ray tubes CFL1 to CFL8 are respectively connected with an inverter printed circuit board IB, which is arranged on a back surface of the chassis CS, for example, and power is supplied to the cold cathode ray tubes CFL1 to CFL8 via the inverter printed circuit board IB.

On an observer-side surface of the liquid crystal display panel PNL, there is a frame FR in which an opening (display window) DF is formed, which opening the display part AR of the liquid crystal display panel PNL in an opposed manner, while side surfaces of the frame FR are fixed to the chassis CS of the backlight BL by caulking or the like, for example.

FIG. 1A is a plan view showing the constitution of the above-mentioned inverter printed circuit board IB. The inverter printed circuit board IB is configured such that a signal is supplied to the inverter printed circuit board IB from a liquid crystal display control circuit (indicated as a TCON printed circuit board in the drawing), and a circuit which adjusts the power source frequency to the cold cathode ray tubes CFL and the like are incorporated in the inverter printed circuit board IB.

Further, at an output portion of the inverter printed circuit board IB, that is, at an output portion for supplying power to the above-mentioned respective cold cathode ray tubes CFL1 to CFL8, connectors CN, which also function as terminals, are arranged. Here, four connectors CN are provided corresponding to the number of respective cold cathode ray tubes CFL. That is, the connectors CN1 to CN4 are sequentially arranged from one end to another end of the group of connectors.

The connector CN1 is allocated to the cold cathode ray tubes CFL1 and CFL2 so as to supply power to the cold cathode ray tubes CFL1 and CFL2, respectively. The connector CN2 is allocated to the cold cathode ray tubes CFL3 and CFL4 so as to supply power to the cold cathode ray tubes CFL3 and CFL4, respectively. The connector CN3 is allocated to the cold cathode ray tubes CFL5 and CFL6 so as to supply power to the cold cathode ray tubes CFL5 and CFL6, respectively. The connector CN4 is allocated to the cold cathode ray tubes CFL7 and CFL8 so as to supply power to the cold cathode ray tubes CFL7 and CFL8, respectively.

Here, to the cold cathode ray tubes CFL1 and CFL2, to which power is supplied via the connector CN1, a voltage signal having a waveform shown in line (2) in FIG. 1B is supplied. That is, assuming a case in which the frequency is 50 kHz and a period t [μs] is taken on the abscissas, a positive voltage signal formed of a sinusoidal wave is supplied at 0t, 20t, 40t, 60t, . . . , and a negative voltage signal formed of a sinusoidal wave is supplied at 10t, 30t, 50t, 70t, . . . .

Further, to the cold cathode ray tubes CFL3 and CFL4, to which power is supplied via the connector CN2, a voltage signal having a waveform shown in line (3) in FIG. 1B is supplied. That is, assuming a case in which the frequency is 50 kHz, a positive voltage signal formed of a sinusoidal wave is supplied at 10t, 30t, 50t, 70t, . . . , and a negative voltage signal formed of a sinusoidal wave is supplied at 0t, 20t, 40t, 60t, . . . .

Further, to the cold cathode ray tubes CFL5 and CFL6, to which power is supplied via the connector CN3, a voltage signal having a waveform similar to the waveform shown in line (2) in FIG. 1B is supplied. Still further, to the cold cathode ray tubes CFL7 and CFL8, to which power is supplied via the connector CN4, a voltage signal having a waveform similar to the waveform shown in line (3) in FIG. 1B is supplied.

In this manner, line (2) in FIG. 1B shows the waveform of the voltage signal supplied to the cold cathode ray tubes CFL which are connected with odd-numbered connectors, such as CN1, CN3, while line (3) in FIG. 1B shows the waveform of the voltage signal supplied to the cold cathode ray tubes CFL which are connected with even-numbered connectors, such as CN2, CN4. That is, FIG. 1B shows that the phase difference between the waveforms shown in lines (2) and (3) is 180°. Here, line (1) in FIG. 1B indicates a data writing signal.

As can be understood from the above description, the signal waveforms of the power source voltages supplied to the respective cold cathode ray tubes CFL1 to CFL8 have the same frequency as the frequency for data writing in the liquid crystal display panel PNL; and, at the same time, the cold cathode ray tubes CFL are formed into groups from the upper side as seen in the drawing, in a state in which each group consists of two cold cathode ray tubes CFL. Hence, the respective cold cathode ray tubes CFL in the neighboring groups are driven with the driving voltages having waveforms which are inverted relative to each other.

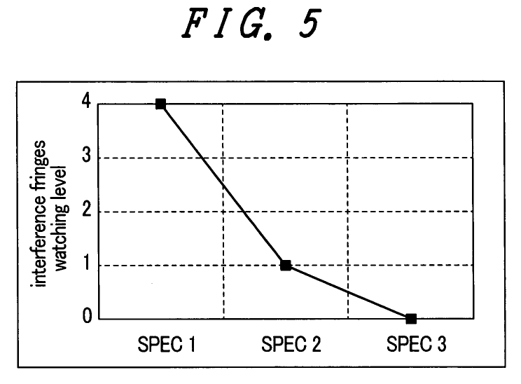

Due to such a constitution, it is possible to obviate the interference fringe which is observed with the naked eye on the liquid crystal display part AR of the liquid crystal display panel PNL without using an ITO sheet, for example, which has been used conventionally. FIG. 5 shows a graph of experimental results which indicate a case (specification 1) in which the liquid crystal display panel PNL is driven without inverting the power supplied to the cold cathode ray tubes CFL and without synchronizing the supply of power with the data writing; a case (specification 2) in which the power supplied to the cold cathode ray tubes CFL is inverted without synchronizing the supply of power with the data writing; and a case in which the power supplied to the cold cathode ray tubes CFL is inverted and the supply of power is synchronized with the data writing (specification 3). An interference fringe naked-eye observation level is taken on the ordinates of the graph, wherein the level 0 indicates that there is no interference fringe, the level 1 indicates that the interference fringe is extremely weak, the level 2 indicates that the interference fringe is less weak, the level 3 indicates that the interference fringe is intermediate, and the level 4 indicates that the interference fringe is strong.

As can be clearly understood from this experimental data, the case (specification 3) corresponds to the case described in conjunction with the above-mentioned embodiment, wherein the observation of the interference fringe with the naked eye can be completely prevented.

Here, although this embodiment shows a constitution in which two cold cathode ray tubes CFL are connected to one connector, it may be possible to adopt a constitution in which three or more cold cathode ray tubes CFL are connected to one connector.

Further, according to the above-mentioned embodiment, the plurality of (for example, two) cold cathode ray tubes CFL in each group are driven with a non-inverted driving waveform; and, hence, the connector CN which supplies the power to these cold cathode ray tubes CFL can be constituted simply to an extent that the connector CN can withstand the voltage which drives the respective cold cathode ray tubes.

In other words, when a plurality of (for example, two) cold cathode ray tubes in each group are driven by driving voltages having waveforms which are inverted relative to each other, there arises a drawback that it is necessary to constitute the liquid crystal display panel such that the liquid crystal display panel can withstand a voltage which corresponds to a value twice as large as the voltage for driving the respective cold cathode ray tubes. This embodiment can provide the constitution which can obviate such a drawback.

FIG. 4 is a diagram showing another embodiment of the liquid crystal display device according to the invention in which cold cathode ray tubes CFL are incorporated into the backlight BL. The constitution which makes this embodiment different from the embodiment shown in FIG. 1 lies in the fact that the cold cathode ray tubes CFL1, CFL3, CFL5 and CFL7 receive the supply voltage of the power source via a connector A on one longitudinal side of the respective cold cathode ray tubes CFL, and the cold cathode ray tubes CFL2, CFL4, CFL6 and CFL8 receive the supply voltage of the power source via a connector B on the opposite longitudinal side of the respective cold cathode ray tubes CFL.

Here, the connector A and the connector B may be constituted as separate elements and need not be integrally formed.

With respect to other constitutions, this embodiment is substantially the same as the above-mentioned embodiment. That is, the respective cold cathode ray tubes CFL are driven with voltages having signal waveforms of the same frequency as that used in the data writing of the liquid crystal display panel PNL, while the cold cathode ray tubes CFL1, CFL3, CFL5 and CFL7 are driven with voltages having signal waveforms which are inverted with respect to those driving the cold cathode ray tubes CFL2, CFL4, CFL6 and CFL8.

Also, in such a case, the cold cathode ray tubes CFL1, CFL3, CFL5 and CFL7 are respectively driven with the non-inverted driving waveform and the connector A which supplies the power to these cold cathode ray tubes may be configured simply to an extent that the connector A can withstand the voltage which drives the respective cold cathode ray tubes. The same goes for the connector B.

The above-mentioned respective embodiments may be used in a single form or in combination. This is because the advantageous effects of the respective embodiments can be obtained individually or synergistically.

Here, the respective cold cathode ray tubes are formed into groups in association with a respective connector in this embodiment, because the invention is advantageous when the connector of a simple type (a low dielectric-strength product) is used gin which one connector covers all waveforms of the same phase. Accordingly, with the use of a connector which exhibits a high dielectric strength, the grouping according to the invention can be carried out in accordance with a unit which is constituted of a plurality of cold cathode ray tubes CFL without being associated with a particular connector.

That is, provided that a connector of high dielectric strength can be used, in the liquid crystal display device which includes a liquid crystal panel and in which a plurality of linear light sources are arranged in parallel in a state in which the linear light sources face the liquid crystal display panel in an is opposed manner, it is possible to provide a constitution in which the plurality of linear light sources are driven with a voltage having a signal waveform of the same frequency as that used in the data writing of the liquid crystal display panel, in which two or more neighboring linear light sources are formed into a group, and in which the respective linear light sources of each group are driven with a voltage having a signal waveform that is inverted with respect to the respective light sources of another neighboring group.

1. A liquid crystal display device comprising:
a liquid crystal display panel; and
a plurality of linear light sources which are arranged in parallel in a plane which faces at least a liquid crystal display part of the liquid crystal display panel, wherein
the plurality of linear light sources which are driven with a signal wave form having the same frequency as data writing of the liquid crystal display panel and are arranged close to each other are formed into each group, and
the respective linear light sources of each group formed into the group are driven with the signal waveform which is inverted with respect to the respective light sources of neighboring another group, and the signal waveform is supplied from a connector different from a connector for the respective linear light sources of another group.

2. A liquid crystal display device according to claim 1, wherein the connector which is connected with the linear light sources of each group are configured separately from the connector which is connected with another group of light sources.

3. A liquid crystal display device according to claim 1, wherein the plurality of connectors are arranged on one longitudinal side of the respective linear light sources.

4. A liquid crystal display device according to claim 1, wherein the linear light sources are formed into the group in a state that each group is constituted of two linear light sources.

5. A liquid crystal display device comprising:
a liquid crystal display panel; and
a plurality of linear light sources which are arranged in parallel in a plane which faces at least a liquid crystal display part of the liquid crystal display panel, wherein
the plurality of linear light sources are driven with a signal waveform having the same frequency as data writing of the liquid crystal display panel and are divided into the linear light sources of one group and the linear light sources of another group which are divided every one or every plurality of linear light sources in the parallel-arranged direction, and
the signal waveform which is inverted with respect to the respective linear light sources of another group is supplied to the respective linear light sources of one group, and the supply of the signal waveform is performed by a connector different from a connector for the respective linear light sources of another group.

6. A liquid crystal display device according to claim 5, wherein
the respective linear light sources are divided into a plurality of groups along the parallel-arranged direction,
in each group, the respective linear light sources are divided into the respective linear light sources of one group and another group which are divided every one other in the parallel-arranged direction,
the signal waveform which is inverted with respect to the respective linear light sources of another group is supplied to the respective linear light sources of one group, and the supply of the signal waveform is performed by a connector different from a connector for the respective linear light sources of another group.

7. A liquid crystal display device according to claim 5, wherein
the connector which supplies the signal waveform to the respective linear light sources of one group is arranged on one longitudinal side of the linear light sources, and
the connector which supplies the signal waveform to the respective linear light sources of another group is arranged on another longitudinal side of the linear light sources.

8. A liquid crystal display device according to claim 6, wherein
the connector which supplies the signal waveform to the respective linear light sources of one group is arranged on one longitudinal side of the linear light sources, and
the connector which supplies the signal waveform to the respective linear light sources of another group is arranged on another longitudinal side of the linear light sources.

9. A liquid crystal display device comprising:
a liquid crystal display panel; and
a plurality of linear light sources which are arranged in parallel in a state that the linear light sources face the liquid crystal display panel, wherein
the plurality of linear light sources which are driven with a signal waveform having the same frequency as data writing of the liquid crystal display panel and are formed into groups in a state that two or more neighboring linear light sources are formed into a group, and
the respective linear light sources of each group formed into the group are driven with the signal waveform which is inverted with respect to the respective light sources of neighboring another group.
